(19) United States
(12) Patent Application Publication
(10) Pub. No.: US 2014/0303311 A1
(43) Pub. Date: Oct. 9, 2014

(54) POLYAMIDE MOLDING COMPOUNDS

(71) Applicants: Sachin Jain, Jalgaon MH (IN); Sameer Nalawade, Mannheim (DE)

(72) Inventors: Sachin Jain, Jalgaon MH (IN); Sameer Nalawade, Mannheim (DE)

(73) Assignee: BASF SE, Ludwigshafen (DE)

(21) Appl. No.: 14/346,407

(22) PCT Filed: Sep. 12, 2012
(86) PCT No.: PCT/EP2012/067796

§ 371 Date: Jun. 4, 2014

(30) Foreign Application Priority Data
Sep. 21, 2011 (EP) 11182184.9

(51) Int. Cl. C08L 77/02

(52) U.S. Cl. CPC C08L 77/02
USPC 524/538

(57) ABSTRACT

The present invention relates to thermoplastic molding compositions comprising:
A) from 80 to 99.5% by weight, based on components A and B, of a polyamide A;
B) from 0.5 to 20% by weight, based on components A and B, of a copolyester B having an intrinsic viscosity according to DIN 53728 of from 150 to 320 cm³/g comprising:
   B₁) from 40 to 80% by weight, based on the total weight of components B₁ and B₂, of at least one succinic, adipic, azelaic, sebacic or brassylic acid, or their ester-forming derivatives, or a mixture thereof,
   B₂) from 20 to 60% by weight, based on the total weight of components B1 and B2, of terephthalic acid, or its ester-forming derivatives, or a mixture thereof,
   B₃) from 98 to 102 mol %, based on components B₁ and B₂, of 1,4-butanediol or 1,3-propanediol, or a mixture thereof, as diol component,
   B₄) from 0 to 1% by weight, based on component B, of a branching agent,
   B₅) from 0 to 2% by weight, based on component B, of a chain extender,
   B₆) from 0 to 2% by weight, based on component B, of further additional materials;
C) from 0 to 60% by weight, based on components A to D, of a fibrous reinforcing material C;
D) from 0 to 10% by weight, based on components A to D, of further additional materials D.

The invention further relates to a process for increasing the notched impact resistance in polyamides, and also to the use of the abovementioned molding compositions for producing fibers, foils, and moldings, and also to fibers, foils, and moldings obtainable from said molding compositions.

The present invention relates to thermoplastic molding compositions comprising:
A) from 80 to 99.5% by weight, based on components A and B, of a polyamide A;
B) from 0.5 to 20% by weight, based on components A and B, of a copolyester B having an intrinsic viscosity according to DIN 53728 of from 150 to 320 cm³/g comprising:
   B₁) from 40 to 80% by weight, based on the total weight of components B₁ and B₂, of at least one succinic, adipic, azelaic, sebacic or brassylic acid, or their ester-forming derivatives, or a mixture thereof,
   B₂) from 20 to 60% by weight, based on the total weight of components B₁ and B₂, of terephthalic acid, or its ester-forming derivatives, or a mixture thereof,
   B₃) from 98 to 102 mol %, based on components B₁ and B₂, of 1,4-butanediol or 1,3-propanediol, or a mixture thereof, as diol component,
   B₄) from 0 to 1% by weight, based on component B, of a branching agent,
   B₅) from 0 to 2% by weight, based on component B, of a chain extender,
   B6) from 0 to 2% by weight, based on component B, of further additional materials
C) from 0 to 60% by weight, based on components A to D, of a fibrous reinforcing material C;
D) from 0 to 10% by weight, based on components A to D, of further additional materials D.

The invention further relates to a process for increasing the notched impact resistance of polyamides, and also to the use of the abovementioned molding compositions for producing fibers, foils, and moldings, and also to fibers, foils, and moldings obtainable from said molding compositions.

Engineering plastics, such as polyamide, generally have very good mechanical properties. However, the impact resistance, and in particular notched impact resistance, of polyamides is still too low for some applications. Although notched impact resistance increases in glassfiber-reinforced polyamide, there is mostly an associated reduction in tensile-strain-at-break performance.

In other plastics, this problem can be solved by adding low-molecular-weight substances (plasticizer). However, the familiar polyamides nylon-6 and nylon-6,6 are incompatible with most plasticizers. They have limited compatibility even with specialized plasticizers, such as N-substituted aromatic sulfonamides. Plasticizers therefore have no great importance for polyamides in general and in particular for the polyamides nylon-6 and nylon-6,6.

It was accordingly an object of the present invention to discover a plasticizer which is compatible with the familiar polyamides and which simultaneously improves impact performance and tensile performance.

Surprisingly, it has been found that incorporation of from 0.5 to 20% by weight of a polyester B can improve the impact performance and tensile performance of the polyamides. Polyester B has good compatibility in the stated quantitative proportions with the familiar polyamides nylon-6 and nylon-6,6.

A more detailed description of the invention follows:

The molding compositions of the invention comprise, as component A, from 80 to 99.5% by weight, preferably from 85 to 99% by weight, and with particular preference from 85 to 95% by weight, based on components A and B, of at least one polyamide.

The polyamides of the molding compositions of the invention generally have an intrinsic viscosity of from 90 to 350 ml/g, preferably from 110 to 240 ml/g, determined in a 0.5% strength by weight solution in 96% strength by weight sulfuric acid at 25° C. to ISO 307.

Preference is given to semicrystalline or amorphous resins with a molecular weight (weight average) of at least 5000, as described by way of example in the following U.S. Pat. Nos. 2,071,250, 2,071,251, 2,130,523, 2,130,948, 2,241,322, 2,312,966, 2,512,606, and 3,393,210.

Examples of these are polyamides that derive from lactams having from 7 to 13 ring members, e.g. polycaprolactam, polycapryllactam, and polylaurolactam, and also polyamides obtained via reaction of dicarboxylic acids with diamines.

Dicarboxylic acids which may be used are alkanedicarboxylic acids having 6 to 12, in particular 6 to 10, carbon atoms, and aromatic dicarboxylic acids. Merely as examples, acids that may be mentioned here are adipic acid, azelaic acid, sebacic acid, dodecanedioic acid and terephthalic and/or isophthalic acid.

Particularly suitable diamines are alkanediamines having from 6 to 12, in particular from 6 to 8, carbon atoms, and also m-xylylenediamine (e.g. Ultramid® X17 from BASF SE, where the molar ratio of MXDA to adipic acid is 1:1), di(4-aminophenyl)methane, di(4-aminocyclohexyl)methane, 2,2-di(4-aminophenyl)propane, 2,2-di(4-aminocyclohexyl)propane, and 1,5-diamino-2-methylpentane.

Preferred polyamides are polyhexamethyleneadipamide, polyhexamethylenesebacamide, and polycaprolactam, and also nylon-6/6,6 copolyamides, in particular having a proportion of from 5 to 95% by weight of caprolactam units (e.g. Ultramid® C31 from BASF SE).

Other suitable polyamides are obtainable from ω-aminoalkylnitriles, e.g. aminocapronitrile (PA 6) and adipodinitrile with hexamethylenediamine (PA 66) via what is known as direct polymerization in the presence of water, for example as described in DE-A 10313681, EP-A 1198491 and EP 922065.

Mention may also be made of polyamides obtainable, by way of example, via condensation of 1,4-diaminobutane with adipic acid at an elevated temperature (nylon-4,6). Preparation processes for polyamides of this structure are described by way of example in EP-A 38 094, EP-A 38 582, and EP-A 39 524.

Other suitable examples are polyamides obtainable via copolymerization of two or more of the abovementioned monomers, and mixtures of two or more polyamides in any desired mixing ratio. Particular preference is given to mixtures of nylon-6,6 with other polyamides, in particular nylon-6/6,6 copolyamides.

Other copolyamides which have proven particularly advantageous are semiaromatic copolyamides, such as PA 6/6T and PA 66/6T, where the triamine content of these is less than 0.5% by weight, preferably less than 0.3% by weight (see EP-A 299 444). Other polyamides resistant to high temperatures are known from EP-A 19 94 075 (PA 6T/6I/MXD6).

The processes described in EP-A 129 195 and 129 196 can be used to prepare the preferred semiaromatic copolyamides with low triamine content.

The following list, which is not comprehensive, comprises the polyamides A mentioned and other polyamides A for the purposes of the invention, and the monomers comprised:

AB polymers:

### PA 4 Pyrrolidone

### PA 6 ε-Caprolactam

### PA 7 Ethanolactam

### PA 8 Capryllactam

PA 9 9-Aminopelargonic acid
PA 11 11-Aminoundecanoic acid

### PA 12 Laurolactam

AA/BB polymers:
PA 46 Tetramethylenediamine, adipic acid
PA 66 Hexamethylenediamine, adipic acid
PA 69 Hexamethylenediamine, azelaic acid
PA 610 Hexamethylenediamine, sebacic acid
PA 612 Hexamethylenediamine, decanedicarboxylic acid
PA 613 Hexamethylenediamine, undecanedicarboxylic acid
PA 1212 1,12-Dodecanediamine, decanedicarboxylic acid
PA 1313 1,13-Diaminotridecane, undecanedicarboxylic acid
PA 6T Hexamethylenediamine, terephthalic acid
PA 9T 1,9-Nonanediamine, terephthalic acid
PA MXD6 m-Xylylenediamine, adipic acid
AA/BB polymers:
PA 6I Hexamethylenediamine, isophthalic acid
PA 6-3-T Trimethylhexamethylenediamine, terephthalic acid

### PA 6/6T (see PA 6 and PA 6T)

### PA 6/66 (see PA 6 and PA 66)

### PA 6/12 (see PA 6 and PA 12)

### PA 66/6/610 (see PA 66, PA 6 and PA 610)

### PA 6I/6T (see PA 6I and PA 6T)

PA PACM 12 Diaminodicyclohexylmethane, laurolactam
PA 6I/6T/PACM as PA 6I/6T diaminodicyclohexylmethane
PA 12/MACMI Laurolactam, dimethyldiaminodicyclohexylmethane, isophthalic acid
PA 12/MACMT Laurolactam, dimethyldiaminodicyclohexylmethane, terephthalic acid
PA PDA-T Phenylenediamine, terephthalic acid

Component B is semiaromatic (aliphatic-aromatic) polyesters. The molding compositions of the invention comprise from 0.5 to 20% by weight, preferably from 1 to 15% by weight, and with particular preference from 5 to 15% by weight, based on components A and B, of component B.

Semiaromatic polyesters are composed of aliphatic diols and of aliphatic, and also aromatic, dicarboxylic acids. Among the suitable semiaromatic polyesters are linear non-chain-extended polyesters (WO 92/09654). Particularly suitable mixture components are aliphatic/aromatic polyesters made of butanediol, terephthalic acid, and aliphatic C₄-C₁₈-dicarboxylic acids, such as succinic acid, glutaric acid, adipic acid, suberic acid, azelaic acid, sebacic acid, and brassylic acid (for example as described in WO 2006/097353 to 56). It is preferable to use, as component B, chain-extended and/or branched semiaromatic polyesters. The latter are known from the specifications WO 96/15173 to 15176, and WO 98/12242 mentioned at the outset, these being expressly incorporated herein by way of reference. It is also possible to use a mixture of various semiaromatic polyesters.

The biodegradable, aliphatic-aromatic copolyesters B comprise:
B₁) from 40 to 80% by weight, based on the total weight of components B₁ and B₂, of at least one succinic, adipic, azelaic, sebacic or brassylic acid, or their ester-forming derivatives, or a mixture thereof,
B₂) from 20 to 60% by weight, based on the total weight of components B₁ and B₂, of terephthalic acid, or its ester-forming derivatives, or a mixture thereof,
B₃) from 98 to 102 mol %, based on components B₁ and B₂, of 1,4-butanediol or 1,3-propanediol, or a mixture thereof, as diol component,
B₄) from 0 to 1% by weight, based on component B, of a branching agent,
B₅) from 0 to 2% by weight, based on component B, of a chain extender,
B₆) from 0 to 2% by weight, based on component B, of further additional materials.

Aliphatic-aromatic polyesters B used with preference comprise:
B₁) from 40 to 60% by weight, based on the total weight of components B₁ and B₂, of at least one succinic, adipic, azelaic, sebacic or brassylic acid, or their ester-forming derivatives, or a mixture thereof,
B₂) from 40 to 60% by weight, based on the total weight of components B₁ and B₂, of terephthalic acid, or its ester-forming derivatives, or a mixture thereof,
B₃) from 98 to 102 mol %, based on components B₁ and B₂, of 1,4-butanediol or 1,3-propanediol, or a mixture thereof, as diol component,
B₄) from 0 to 1% by weight, based on component B, of a branching agent,
B₅) from 0.1 to 2% by weight, based on component B, of a chain extender,
B₆) from 0 to 2% by weight, based on component B, of further additional materials.

Aliphatic dicarboxylic acids that are preferably suitable are succinic acid, adipic acid, and with particular preference sebacic acid. An advantage of the diacids mentioned is that they are also available in the form of renewable raw materials.

The copolyesters B described are synthesized by the processes described in WO-A 92/09654 or WO-A 96/15173, or preferably by the processes described in WO-A 09/127555 and WO-A 09/127556, preferably in a two-stage reaction cascade. The dicarboxylic acid derivatives are first reacted together with a diol in the presence of a transesterification catalyst to give a prepolyester. The intrinsic viscosity (IV) of said prepolyester is generally from 50 to 100 mL/g, preferably from 60 to 80 mL/g. Catalysts used usually comprise zinc catalysts, aluminum catalysts, and in particular titanium catalysts. An advantage of titanium catalysts, such as tetra(isopropyl) orthotitanate and in particular tetrabutyl orthotitanate (TBOT) over the tin catalysts, antimony catalysts, cobalt catalysts, and lead catalysts frequently used in the literature, for example tin dioctanoate, is that any residual amounts of the catalyst remaining in the product, or any downstream product of the catalyst, is/are less toxic. This is a particularly important matter in the case of the biodegradable polyesters, since the materials can pass directly into the environment by way of the composting process.

A second step then produces the polyesters B by the processes described in WO-A 96/15173 and EP-A 488 617. The prepolyester is reacted in a chain-extension reaction with chain extenders B₅, for example with polymethacrylates containing epoxy groups or with diisocyanates, to give a polyester with an intrinsic viscosity according to DIN 53728 (IV) of from 150 to 320 mL(cm³)/g, preferably from 180 to 250 mL/g.

The process generally uses from 0.01 to 2% by weight, preferably from 0.1 to 2.0% by weight, and with particular preference from 0.1 to 1.0% by weight, based on the total weight of component B, of a branching agent (B₄) and/or chain extender (B₅) selected from the group consisting of: a polyfunctional isocyanate, isocyanurate, oxazoline, epoxide, peroxide, carboxylic anhydride, an at least trihydric alcohol, or an at least tribasic carboxylic acid. Chain extenders B₅ used can be polyfunctional and in particular difunctional isocyanates, isocyanurates, oxazolines, carboxylic anhydride, or epoxides.

Chain extenders, and also alcohols or carboxylic acid derivatives having at least three functional groups, can also be considered to be branching agents B₄. Particularly preferred compounds have from three to six functional groups. Examples that may be mentioned are: tartaric acid, citric acid, malic acid; trimethylolpropane, trimethylolethane; pentaerythritol; polyethertriols and glycerol, trimesic acid, trimellitic acid, trimellitic anhydride, pyromellitic acid, and pyromellitic dianhydride. Preference is given to polyols, such as trimethylolpropane, pentaerythritol, and in particular glycerol. By using components B₄ and B₅ it is possible to construct biodegradable polyesters which are pseudoplastic. The rheology of the melts improves; and the biodegradable polyesters are easier to process. The compounds B₅ have a shear-thinning effect, and the viscosity at higher shear rates is therefore reduced.

The number-average molar mass (Mn) of the polyesters B is generally in the range from 10 000 to 100 000 g/mol, in particular in the range from 15 000 to 75 000 g/mol, preferably in the range from 20 000 to 38 000 g/mol, and their weight-average molar mass (Mw) is generally from 30 000 to 300 000 g/mol, preferably from 60 000 to 200 000 g/mol, and their Mw/Mn ratio is generally from 1 to 6, preferably from 2 to 4. Intrinsic viscosity is from 150 to 320 g/mL, preferably from 180 to 250 mL/g (measured in o-dichlorobenzene/phenol (ratio by weight 50/50)). Melting point is in the range from 85 to 150° C., preferably in the range from 95 to 140° C.

The polyesters mentioned can have hydroxy and/or carboxy end groups in any desired ratio. The semiaromatic polyesters mentioned can also be end-group-modified. By way of example, OH end groups can be acid-modified via reaction with phthalic acid, phthalic anhydride, trimellitic acid, trimellitic anhydride, pyromellitic acid, or pyromellitic anhydride. Preference is given to polyesters with acid numbers smaller than 1.5 mg KOH/g.

The biodegradable polyesters B can comprise further additional materials B6 which are known to the person skilled in the art but which are not essential to the invention. Examples are the additional materials conventional in plastics technology, e.g. stabilizers; nucleating agents; lubricants and release agents, e.g. stearates (in particular calcium stearate); plasticizers, e.g. citric esters (in particular tributyl acetylcitrate), glycerol esters, such as triacetylglycerol, or ethylene glycol derivatives, surfactants, such as polysorbates, palmitates, or laurates; waxes, for example beeswax or beeswax esters; antistatic agent, UV absorbers; UV stabilizers; antifogging agents, or dyes. The concentrations used of the additives are from 0 to 5% by weight, in particular from 0.1 to 2% by weight, based on the polyesters of the invention.

The amounts used of the fibrous reinforcing material C are from 0 to 60% by weight, in particular from 5 to 50% by weight, and with particular preference from 20 to 50% by weight, based on components A to D.

Preferred fibrous fillers C that may be mentioned are carbon fibers, aramid fibers, glass fibers, and potassium titanate fibers, particular preference being given here to glass fibers in the form of E glass. These are used in the form of rovings in the forms commercially available.

The glass fibers used in the form of roving in the invention have a diameter of from 6 to 20 μm, preferably from 10 to 18 μm, and the cross section of the glass fibers here is round, oval, or polyhedral. In particular, the invention uses E glass fibers. However, it is possible to use any of the other types of glass fiber, e.g. A, C, D, M, S, or R glass fibers, or any desired mixture thereof, or a mixture with E glass fibers.

The fibrous fillers can have been surface-pretreated with a silane compound in order to improve compatibility with the thermoplastics.

Suitable silane compounds have the general formula:

(X—(CH₂)ₙ)(ₖ—Si—(O—CₘH₂ₘ₊₁)₄₋ₖ

where the definitions of the substituents are as follows:

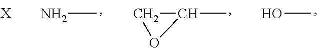

n is an integer from 2 to 10, preferably 3 to 4,

m is an integer from 1 to 5, preferably 1 to 2, and

k is an integer from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group as substituent X.

The amounts of the silane compounds generally used for surface-coating are from 0.01 to 2% by weight, preferably from 0.025 to 1.0% by weight and in particular from 0.05 to 0.5% by weight (based on C)).

Other suitable coating compositions (also termed size) are based on isocyanates.

Preference is given to use of long glass fibers with length from 3 to 24 mm and with L/D (length/diameter) ratio from 100 to 4000, in particular from 350 to 2000, and very particularly from 350 to 700.

The amounts used of the additional materials D are from 0 to 10% by weight, in particular from 0.5 to 5% by weight, based on components A to D. The high proportions by weight can in particular be used for fillers.

By way of example, acicular mineral fillers are suitable.

For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may optionally have been pretreated with the abovementioned silane compounds, but the pretreatment is not essential.

Further fillers that may be mentioned are kaolin, calcined kaolin, wollastonite, talc and chalk, and also lamellar or acicular nanofillers, the amounts of these preferably being from 0.1 to 10%. Materials preferred for this purpose are boehmite, bentonite, montmorillonite, vermiculite, hectorite, and laponite. The lamellar nanofillers are organically modified by prior-art methods, to give them good compatibility with the organic binder. Addition of the lamellar or acicular nanofillers to the nanocomposites of the invention leads to a further increase in mechanical strength.

The thermoplastic molding compositions also advantageously comprise a lubricant D; from 0 to 3% by weight, preferably from 0.05 to 3% by weight, with preference from 0.1 to 1.5% by weight, and in particular from 0.1 to 1% by weight, based on the total amount of components A to D, comprised.

Preference is given to the salts of aluminum, of alkali metals, of alkaline earth metals, or to esters or amides of fatty acids having from 10 to 44 carbon atoms, preferably having from 14 to 44 carbon atoms. The metal ions are preferably alkaline earth metal and aluminum (Al), and particular preference is given here to calcium (Ca) or magnesium. Preferred metal salts are Ca stearate and Ca montanate, and also Al stearate. It is also possible to use a mixture of various salts, in any desired mixing ratio.

The fatty acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols of the esters can be monohydric to tetrahydric. Examples of alcohols are n-butanol, n-octanol, stearyl alcohol, ethylene glycol, propylene glycol, neopentyl glycol, pentaerythritol, preference being given to glycerol and pentaerythritol. The aliphatic amines of the amides can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The thermoplastic molding compositions of the invention can comprise, as further component D, conventional processing aids, such as stabilizers, oxidation retarders, further agents to counter decomposition due to heat and decomposition due to ultraviolet light, lubricants and mold-release agents, colorants, such as dyes and pigments, nucleating agents, plasticizers, flame retardants, rubbers, etc.

Suitable rubbers for polyamides can be found in PCT/EP 2011/059546, which in this connection is explicitly incorporated here by way of reference.

Examples of oxidation retarders and heat stabilizers are phosphites and further amines (e.g. TAD), hydroquinones, various substituted members of these groups, and mixtures of these, in concentrations of up to 1% by weight, based on the weight of the thermoplastic molding compositions.

UV stabilizers that may be mentioned, the amounts of which used are generally up to 2% by weight, based on the molding composition, are various substituted resorcinols, salicylates, benzotriazoles, and benzophenones.

Materials that can be added as colorants are inorganic pigments, such as titanium dioxide, ultramarine blue, iron oxide, and carbon black and /or graphite, and also organic pigments, such as phthalocyanines, quinacridones, perylenes, and also dyes, such as nigrosine and anthraquinones.

Materials that can be used as nucleating agents are sodium phenylphosphinate, aluminum oxide, silicon dioxide, and also preferably talc powder.

Flame retardants that may be mentioned are red phosphorus, P- and N-containing flame retardants, and also halogenated flame retardant systems, and synergists of these.

The thermoplastic molding compositions of the invention can be produced by processes known per se, by mixing the starting components in conventional mixing apparatus, such as screw-based extruders, Brabender mixers, or Banbury mixers, and then extruding the same. After extrusion, the extrudate can be cooled and pelletized. It is also possible to premix individual components and then to add the remaining starting materials individually and/or likewise in the form of a mixture. The mixing temperatures are generally from 230 to 320° C.

In another preferred mode of operation, components B, and also optionally C and D, can be mixed with the polyamide A, compounded, and pelletized. The resultant pellets are then solid-phase condensed under an inert gas continuously or batchwise at a temperature below the melting point of component A until the desired viscosity has been reached.

The thermoplastic molding compositions of the invention feature good processability together with good mechanical properties, and also markedly improved HAR and surface.

These materials are suitable for producing fibers, foils, and moldings of any type. These feature excellent impact performance and excellent tensile performance. A few examples now follow: cylinder head covers, motorcycle covers, intake pipes, charge-air cooler caps, plug connectors, gearwheels, fan wheels, and cooling water tanks.

Improved-flow polyamides can be used in the electrical and electronics sector to produce plugs, plug parts, plug connectors, membrane switches, printed circuit board modules, microelectronic components, coils, I/O plug connectors, plugs for printed circuit boards (PCBs), plugs for flexible printed circuit boards (FPCs), plugs for flexible integrated circuits (FFCs), high-speed plug connections, terminal strips, connector plugs, device connectors, cable harness components, circuit mounts, circuit mount components, three-dimensionally injection-molded circuit mounts, electrical connection elements, and mechatronic components.

Possible internal automobile uses are for dashboards, steering column switches, seat components, headrests, center consoles, gearbox components, and door modules, and possible external automobile uses are for door handles, exterior mirror components, windshield wiper components, windshield wiper protective housings, grilles, roof rails, sunroof frames, engine covers, cylinder head covers, intake pipes (in particular intake manifolds), windshield wipers, and also external bodywork parts.

Possible uses of improved-flow polyamides in the kitchen and household sector are for producing components for kitchen devices, e.g. fryers, smoothing irons, knobs, and also applications in the garden and leisure sector, e.g. components for irrigation systems, or garden devices, and door handles.

### EXAMPLES

### Test Methods and Properties

Instrinsic viscosity was determined according to DIN 53728 Part 3, Jan. 3, 1985. The solvent used was the phenol/dichlorobenzene mixture in a ratio by weight of 50/50.

Charpy notched impact resistance was determined at respectively 23° C. and −30° C. according to ISO 179-2/1eA.

Yield stress, modulus of elasticity, and tensile strain at break were determined according to ISO 527-2:1993. The tensile testing speed was 5 mm/min.

### Starting Materials

The following components were used:

### Component A:

Ai: Ultramid® B27E: nylon-6 from BASF SE (CAS:25038-54-4, density: 1120-1150 g/l, melting point: 220° C., relative viscosity (1% in 96% H₂SO₄): 2.7±0.03)

### Component B:

Bi: Ecoflex®C1200 (previous product name: Ecoflex® FBX 7011): a polybutylene adipate-co-terephthalate from BASF SE (CAS:55231-08-8, intrinsic viscosity 180 to 250 cm³/g, melting point 110 to 115° C.)

### Component C:

Ci: TufRov®4510: glass fibers from PPG Fiber Glass Europe (E-glass, ASTM D578-98, silane size, 17 micrometers fiber diameter, roving tex-2400 (2.4 g/m))

### Component D:

Di: Acrawax C from Lonza AG (composed of N,N′-ethylenebisstearamide (CAS:110-30-5), N,N′-ethane-1,2-diylbishexadecan-1-amide (CAS: 5518-18-3), C₁₄₋₁₈-fatty acids (CAS: 67701-02-4), melting point: 140-145° C.)

Dii: Irganox 98 from BASF SE (N,N′-hexane-1,6-diylbis[3-(3,5-di-tert-butyl-4-hydroxyphenylpropionamide)], CAS number: 23128-74-7, melting point: 156-165° C.)

Diii: IT talc powder from Mondo Minerals (CAS: 14807-96-6, density: 2750 g/l)

### EXAMPLES 1 TO 3

The molding compositions of comparative example 1 and of inventive examples 2 and 3 were produced at 260° C. with a rotation rate of 300 rpm in a ZSK MC 26:

### Production of Test Specimens

The test specimens used to determine the properties were produced by using a Battenfeld 50 injection-molding machine. The pellets produced in 2) and 3) were melted and injected into the mold with a screw rotation rate of 100 rpm and a residence time of 50 s. The test specimens for the tensile tests were produced according to ISO 527-2/1A/5, and the test specimens for the impact resistance tests were produced to ISO 179-2/1eA(F). Injection temperature was 260° C., and mold temperature was 80° C.

TABLE 1
Effect of component B on impact performance
and tensile performance of polyamide

| Components | Comparative | Inventive | Inventive |
|---|---|---|---|
| [% by wt.] | example 1c | example 2 | example 3 |
| Ai) | 98.61 | 88.75 | 88.75 |
| Bi) | | 5 | 10 |
| Di) | 1.11 | 1.05 | 1 |
| Dii) | 0.22 | 0.21 | 0.2 |
| Diii) | 0.06 | 0.05 | 0.05 |
| Total | 100 | 100 | 100 |
| Charpy notched | 4.4 | 5.8 | 8.7 |
| [kJ/m²] at 23° C. | | | |
| Charpy notched | 2.7 | 2.9 | 3.2 |
| [kJ/m²] at −30° C. | | | |

The constitutions of the molding compositions and the results of the tests can be found in table 1. The notched impact resistance exhibited by inventive example 2 using 5% by weight of copolyester B of the invention at 23° C. (−30° C.) was higher by 32% (7-8%) than that of comparative example 1. The notched impact resistance exhibited by inventive example 3 using 10% by weight of copolyester B of the invention at 23° C. (−30° C.) was higher by 107% (19%) than that of comparative example 1.

Tensile properties: tensile strain at break, tensile strength, and modulus of elasticity, were better in inventive example 3 than in inventive example 2 and were at a level similar to that of comparative example 1c.

1-7. (canceled)

8. A thermoplastic molding composition comprising:
A) from 80 to 99.5% by weight, based on components A and B, of a polyamide A;
B) from 0.5 to 20% by weight, based on components A and B, of a copolyester B having an intrinsic viscosity according to DIN 53728 of from 150 to 320 cm³/g comprising:
B₁) from 40 to 80% by weight, based on the total weight of components B₁ and B₂, of at least one succinic, adipic, azelaic, sebacic or brassylic acid, or their ester-forming derivatives, or a mixture thereof,
B₂) from 20 to 60% by weight, based on the total weight of components B1 and B2, of terephthalic acid, or its ester-forming derivatives, or a mixture thereof,
B₃) from 98 to 102 mol %, based on components B₁ and B₂, of 1,4-butanediol or 1,3-propanediol, or a mixture thereof, as a diol component,
B₄) from 0 to 1% by weight, based on component B, of a branching agent,
B₅) from 0 to 2% by weight, based on component B, of a chain extender,
B₆) from 0 to 2% by weight, based on component B, of further additional materials;
C) from 0 to 60% by weight, based on components A to D, of a fibrous reinforcing material C;
D) from 0 to 10% by weight, based on components A to D, of further additional materials D.

9. The thermoplastic molding composition of claim 8, wherein component B is a copolyester of:
B₁) from 40 to 60% by weight, based on the total weight of components B₁ and B₂, of at least one succinic, adipic, azelaic, sebacic or brassylic acid, or their ester-following derivatives, or a mixture thereof,
B₂) from 40 to 60% by weight, based on the total weight of components B₁ and B₂, of terephthalic acid, or its ester-forming derivatives, or a mixture thereof,
B₃) from 98 to 102 mol %, based on components B₁ and B₂, of 1,4-butanediol or 1,3-propanediol, or a mixture thereof, as a diol component,
B₄) from 0 to 1% by weight, based on component B, of a branching agent,
B₅) from 0.1 to 2% by weight, based on component B, of a chain extender,
B₆) from 0 to 2% by weight, based on component B, of further additional materials.

10. The thermoplastic molding composition of claim 8, wherein the fibrous reinforcing material C is from 20 to 50% by weight, based on components A to D, of a carbon fiber, aramid fiber, or glass fiber.

11. The thermoplastic molding composition of claim 10, wherein the fibrous reinforcing material C is from 20 to 50% by weight, based on components A to D, of glass fibers of length from 3 to 24 mm.

12. A process for increasing the notched impact resistance of polyamides A, said process comprising adding in an amount of from 0.5 to 20% by weight, based on components A and B, a copolyester B having an intrinsic viscosity according to DIN 53728 of from 150 to 320 cm³/g, wherein said copolyester B comprises:
B₁) from 40 to 80% by weight, based on the total weight of components B₁ and B₂, of at least one succinic, adipic, azelaic, sebacic or brassylic acid, or their ester-forming derivatives, or a mixture thereof,
B₂) from 20 to 60% by weight, based on the total weight of components B₁ and B₂, of terephthalic acid, or its ester-forming derivatives, or a mixture thereof,
B₃) from 98 to 102 mol %, based on components B₁ and B₂, of 1,4-butanediol or 1,3-propanediol, or a mixture thereof, as diol component,
B₄) from 0 to 1% by weight, based on component B, of a branching agent,
B₅) from 0 to 2% by weight, based on component B, of a chain extender,
B₆) from 0 to 2% by weight, based on component B, of further additional materials.

13. (canceled)

14. A fiber, a foil, or a molding, obtained from the thermoplastic molding compositions of claim 8.
